(19) United States
(12) Patent Application Publication
(10) Pub. No.: US 2002/0088665 A1
(43) Pub. Date: Jul. 11, 2002

(54) Lift truck

(76) Inventor: Frederick Leslie Brown, Stratford Upon Avon (GB)

Correspondence Address: CARLSON, GASKEY & OLDS, P.C., 400 WEST MAPLE ROAD, SUITE 350, BIRMINGHAM, MI, 48009, US

(21) Appl. No.: 10/043,050

(22) Filed: Jan. 9, 2002

(30) Foreign Application Priority Data
Jan. 10, 2001 (GB) 0100615.4

(51) Int. Cl. B62D 5/06

(52) U.S. Cl. 180/418

(57) ABSTRACT

A lift truck (10) having a body (12) with ground engaging means (14) and a steer frame (34) rotatable relative to the body via a steer pivot having a steer axis (A) with the steer axis being fixed relative to the body, the lift truck further including a mast (50) mounted on a steer frame and being rotatably fast therewith when considering the steer axis, the lift truck further including front wheels (66, 68) depending from and steerable by the steering frame, in which the mast is rotatably fast with the front wheels when considering the steer axis, and the mast is mounted substantially above the steer pivot (FIG. 1).

The present invention relates to lift trucks, and in particular fork lift trucks.

Known fork lift trucks are capable of carrying loads supported on forks, a spike or the like mounted on a mast. The mast is capable of lifting the forks to different heights to place or pick up the load from a racking storage system or bed of a lorry or off the ground etc.

Further known lift trucks are designed to be used within warehouses where they are required to lift loads to significant heights and thus tend to use telescopic masts. Typically the loads will be positioned in some form of racking system accessible via aisles. To maximise space efficiency in the warehouse, it is important to minimise the width of the aisles. The loads positioned on the racking system are inserted and withdrawn from their loading bays in a direction perpendicular to the aisle.

Thus design of warehouse type fork lift trucks has tended to concentrate on narrowing the width of the truck whilst still been able to insert and extract loads into the loading bays.

One method of achieving this aim is to provide a fork lift truck with a traverse mechanism on which the load in mounted. Such a traverse mechanism operates to move the load laterally relative to the fork lift truck. Thus, for example, when a fork lift truck fitted with a traverse mechanism is used to deposit a load in a loading bay down an aisle, the load is positioned central relative to fork lift truck and the fork lift truck is then driven down the aisle to a position such that the load is opposite the load bay. Note that at this point the fork lift truck is still aligned with the aisle (i.e. it has not turned relative to the aisle).

The traverse mechanism is then operated to move the load sideways relative to the fork lift truck and into the load bay whereupon the load is then deposited and the traverse mechanism is then withdrawn and the lift truck can then move out of the aisle.

However, lift trucks having traverse mechanism are limited as to both the length and width of the load that they can carry.

As regards the length of the load, this can be no greater than the stroke of the traverse mechanism since the load must be positioned all the way into its load bay before being deposited. In the event that the load is longer than the stroke of the traverse mechanism, the load can only be partially inserted into the load bay with the result that some of the load projects into the aisle.

Furthermore since the load is turned relative to the body of the truck the width of the load is limited in as much as it must always be clear of the body of the truck.

It should be noted that on lift trucks having traverse mechanisms the length of the lift truck is of secondary importance.

Other forms of lift trucks for use within warehouses are known wherein there is no traverse mechanism and the forks pivot relative to the body of the lift truck. With this form of lift truck, to deposit a load within an aisle the lift truck carries the load towards its load bay within the aisle and then the forks and front part of the lift truck are steered into the load bay to deposit the load. It should be noted that the forks of such lift trucks can be turned at 90 degrees to the body of the lift truck and also that as the forks move into the load bay the back portion the truck swings relative to the aisle. Thus when an operator is depositing a load in the left hand side of an aisle he or she must take care to ensure that the right rear hand side of the lift truck does not strike the racking system etc. on the right hand side of the aisle.

Thus the length of such an a lift truck is of primary importance since the longer the lift truck the more likely is the possibility of the back end of the lift truck striking the racking system of an aisle when manoeuvring loads.

Furthermore when the forks and load are turned at 90 degrees to the body of truck the distance from the end of the load to the centre line of the truck is also of primary importance since by reducing this distance the lift truck can work within narrower aisles.

An object of the present invention is to provide an improved form of lift truck which is capable of working better within an aisle than comparable known lift trucks.

Thus according to the present invention there is provided a lift truck having a body with ground engaging means and a steer frame rotatable relative to the body via a steer pivot having a steer axis with the steer axis being fixed relative to the body, the lift truck further including a mast mounted on a steer frame and being rotatably fast therewith when considering the steer axis, the lift truck further including front wheels depending from and steerable by the steering frame, in which the mast is rotatably fast with the front wheels when considering the steer axis, and the mast is mounted substantially above the steer pivot.

The invention will now be described, by way of example only, with reference to the accompanying drawings in which:

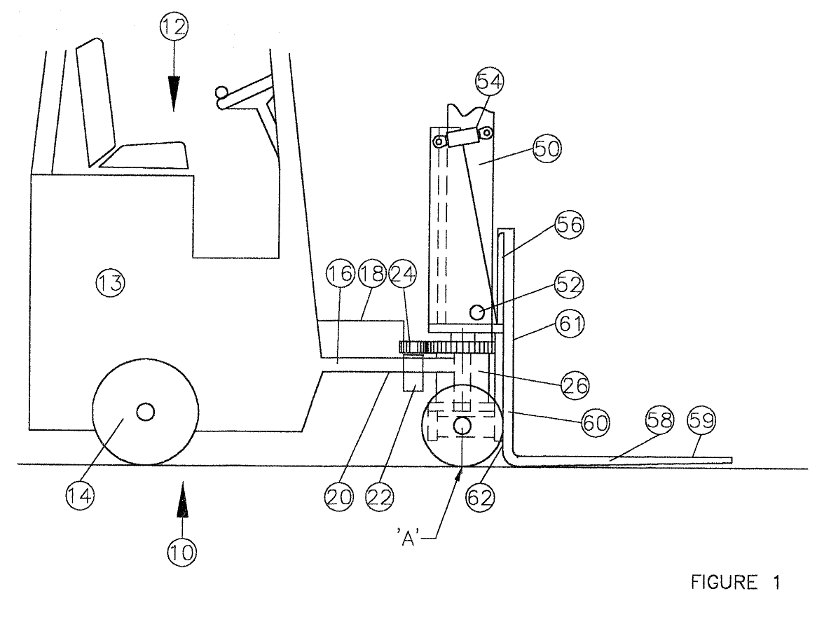

FIG. 1 is a side view of a lift truck according to the present invention;

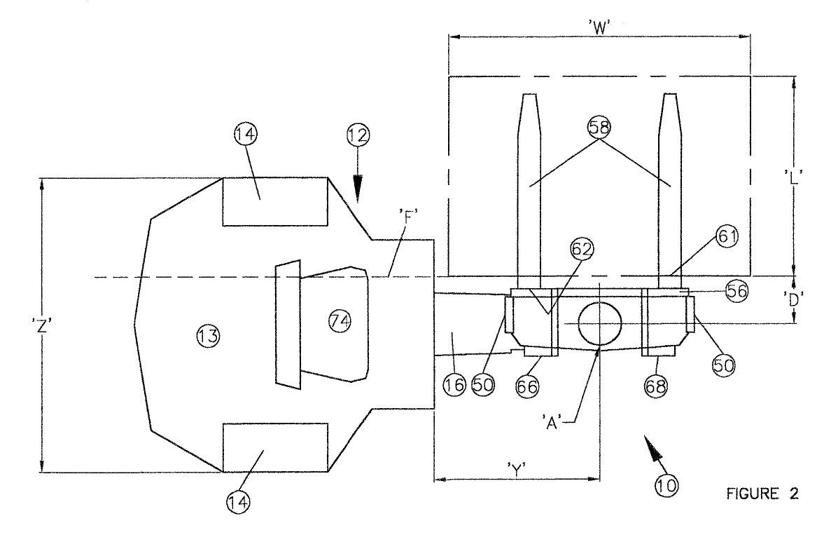

FIG. 2 is a scale plan view of the lift truck of FIG. 1 shown with the load rotated through 90 degrees;

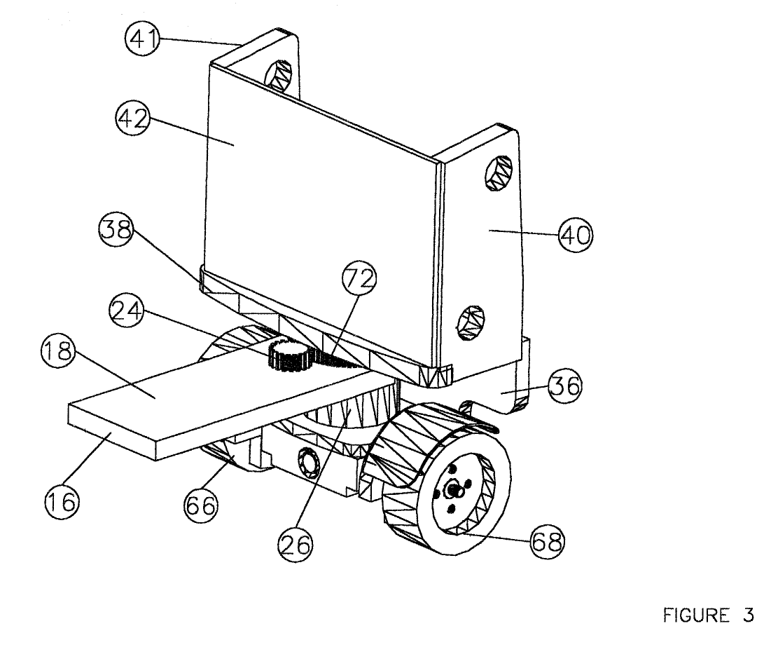

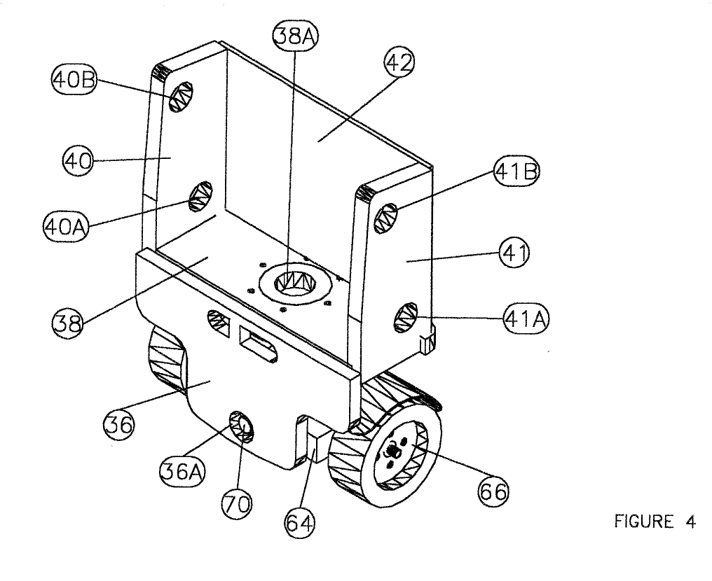

FIGS. 3 and 4 are rear and front isometric views of part of the lift truck of FIG. 1; and

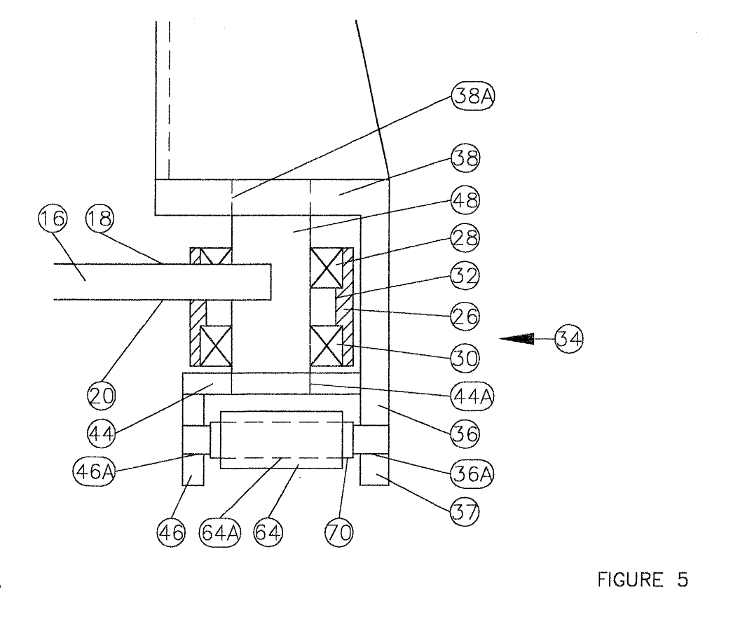

FIG. 5 is a cross section view of part of the lift truck of FIG. 1, with the steering gear wheel not shown for clarity;

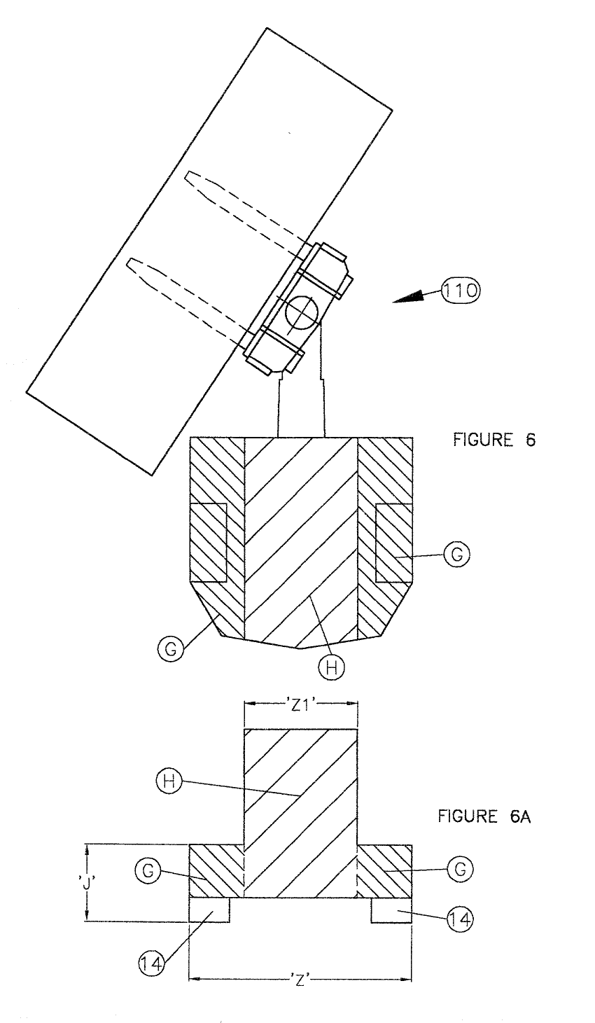

FIG. 6 is a further (larger) embodiment of a lift truck according to the present invention;

FIG. 6A is a rear view of FIG. 6

With reference to FIGS. 1 to 5 there is shown a lift truck 10 having a body 12 with ground engaging means in the form of rear wheels 14. Body 12 includes main body portion 13 and a forward projecting arm 16 having an upper surface 18 and lower surface 20.

Mounted in arm 16 is a steer motor 22 having a pinion 24.

On the end of arm 16 is a bearing housing 26.

Mounted within bearing housing 26 is an upper bearing 28 and a lower bearing 30 separated by a spacer 32. In this case the upper and lower bearings are rotating element taper roller bearings.

With reference to FIGS. 3 and 4 there is shown a steer frame 34 including a vertically mounted front plate 36 secured to a horizontally mounted top plate 38. Side plates 40 and 41 and rear plate 42 depend upwardly from top plate 30.

Side plates 40 and 41 include lower holes 40A and 41A and upper holes 40B and 41B.

Top plate 38 includes hole 38A.

Top plate 38, side plate 40 and 41 and rear plate 42 together form a mast support frame.

A bottom plate 44 is secured to front plate 36 and lies parallel to top plate 38. Bottom plate 44 includes a hole 44A which is aligned with hole 38A.

Top and bottom plate 38 and 44, together with that portion of front plate 36 which joins them together form a ‘U’ shaped structure.

An end 37 of front plate 36 extends beyond bottom plate 44 and includes a hole 36A.

Secured to the rear edge of bottom plate 44 is a downwardly projecting plate 46 which includes a hole 46A which is aligned with hole 36A.

An elongate pin 48 passes through the centre races of the upper and lower bearings 28 and 30 and is secured at opposite ends in holes 38A and 44A. Bearings 28 and 30 together with spacer 32 and elongate pin 48 together define a steer pivot arrangement.

Thus the steer frame 34, elongate pin 48 and inner races of the upper and lower bearings can all rotate in unison relative to arm 16 and in particular body 12.

Mast 50 is pivotally mounted at its lower end on pins 52 (only one shown) which engage holes 40A and 41A.

Two tilt rams 54 (only one shown) are provided with one end of each ram being pivotally mounted in corresponding holes 40B and 41B and the other end being connected to the mast. Operation of the rams causes the mast to pivot about the axis of holes 40A and 41A resulting in it tiling.

In this case mast 50 is a telescoping mast, though in further embodiments this need not be the case.

Mounted on mast 50 is a carriage 56 which is lifted and lowered relative to the mast. Mounted on carriage 56 are forks 58.

In particular it should be noted that the mast is mounted vertically above the steer pivot and also that the tilt axis of the mast (as defined by the axis of holes 40A and 41A) is also vertically above the steer pivot.

The forks 58 include a horizontal portion 59 and a vertical portion 60 having a front surface 61 which acts as a load stop.

It should be noted that vertical portion 60 extends at least from the bottom of the mast vertically downwards to the ground.

An axle 64 includes front wheels 66 and 68 mounted on either end thereof.

The axle 64 includes a hole 64A with an axle pin 70 being mounted in hole 64A and holes 36A and 46A to pivotally mounted the axle relative to the steer frame 34. In particular it can be seen that the axis of the axle pin 70 lies in the straight ahead direction when the steer frame is positioned in the straight ahead direction and allows the axle to roll relative to the steer frame and body 12. This ensures that when the lift truck moves over and uneven surface all four wheels remain in contact with the ground.

Mounted beneath and rotationally fast with the top plate 38 is a steering gear wheel 72 (only shown in FIG. 3 for clarity) which is engaged by pinion 24. Actuation of motor 22 causes pinion 24 to rotate and thus steering gear wheel 72 and hence the steer frame 34 to also rotate to steer the lift truck. In particular it should noted that the axle 64 is substantially vertically below the steer pivot and, that when viewing FIG. 1, the axis of rotation of the front wheels is also substantially vertically below the steer pivot.

It can be seen from FIG. 1 that the upper surface of the front wheels 66 and 68 is at a level which is lower than lower surface 20. Thus when the truck is steered to the left as shown in FIG. 2 wheel 66 can pass underneath arm 16. Similarly when the lift truck is steered to the right wheel 68 can also pass underneath arm 16.

Furthermore it can seen that the lower surface of top plate 38 is at a level which is higher than the upper surface of arm 16. Thus when the truck is steered to the left as shown in FIG. 2 a portion of the top plate, and hence a portion of the mast, can pass over the arm 16. Similarly a different portion of the top plate 38 and a different portion of the mast 50 can pass over the arm 16 when the lift truck is steered to the right.

It should be noted that known non traverse mechanism fork lift trucks designed for use in warehouses have always mounted the mast in front of the steer pivot. The applicant is the first to realise that by mounting the mast above the steer pivot the lift truck can be significantly shortened and the load offset from the centre line of the truck with the forks turned through 90 degrees can also be significantly reduced thus improving its manevourability within an aisle.

If the distance D between the steer axis and load stop is less than half the width Z of the body of the lift truck then such an arrangement limits the width of the load which can be carried if it is necessary to turn the steer frame at 90 degrees to the straight head position.

However, there is no limit on the length of the load that can be carried.

In further arrangements arm 16 could have a pin rotationally secured to the end thereof which project above the arm into the top plate and below the arm into the bottom plate. Bearings could be mounted in the top and bottom plate such that the bearing inner races are rotationally secured to the pin with the bearing outer races being rotationally secured into the corresponding top and bottom plates to allow the steer frame to rotate relative to the truck body. In the embodiments described it is clear that the arm 16 includes an upwardly orientated projection (upper portion of pin) and a downwardly orientated projection (lower portion of pin) which together support the steer frame.

It is also clear that the upwardly orientated projection can be rotatable relative to, or rotationally fast with arm 16, and similarly the downwardly orientated projection can be rotationally fast with or rotatable relative to the arm 16.

In further embodiments the mast can be fixed in a non tiltable manner relative to the steer frame and may include a carriage having a tilting mechanism which tilts the forks relative to the mast.

The dimensions indicated in FIG. 2 are as follows:

W=1500 mm

L=1000 mm

D=194 mm

Z=1255 mm

Y=786 mm

In this case the width and length dimensions of the load have been standardised and the lift truck is primarily designed for loads of these dimensions. It can be seen that half the width W i.e. 750 mm is slightly less than the dimension Y which defines the distance along arm 16 from the body 12 to the steer axis A. This allows the forks to be turned at 90 degrees to the body without the load hitting the body.

It can also be seen that the diameter of the front wheel 66 and 68 is substantially equal to the width of the arm 16 which, generally speaking, is parallel sided.

Consideration of FIG. 1 in conjunction with FIG. 2 shows that the rear face 62 of the vertical portion 60 or the forks 58 lies in close proximity to and substantially against the side of arm 16 when the forks are turned through 90 degrees. Furthermore as shown in FIG. 2 the left hand portion of carriage 56 and the left hand portion of mast 50 lie substantially over wheel 66 when the forks are turned at 90 degrees.

Known fork lift trucks of comparable size wherein the mast is mounted in front of the steer axis will typically have a distance between the load stop and steer axis (i.e. dimension D) of 500 mm. Thus when the load is turned at 90 degrees the end of the load is offset from the centre line of lift truck the length of the load L plus 500 mm.

By providing a lift truck according to the present invention the dimension D can be significantly reduced thus significantly reducing the overhang of the load when the forks are turned at 90 degrees. Thus for a load length of 1 metre the prior art truck would have a load overhang of 1500 mm and an equivalent track according to the present invention would have a load overhang of 1200 mm. This saving in space is of particular benefit when considering that the prior art truck would typically work within an aisle width 1800 mm. Lift trucks according to the present invention can therefore work within significantly narrow aisle widths therefore making significant savings in warehouse space.

FIGS. 6 and 7 show a further embodiment of a lift truck 110 according to the present invention. In this case lift truck is 110 is larger in all dimensions than lift truck 10.

Consideration of FIG. 6 shows, as mentioned above, that with an extra wide load the maximum steer angle can be limited.

It should also be note that the width of the load that can be carried is by lift truck 10 or 110 unlimited provided a predetermined steer angle is not exceeded (see FIG. 6). The applicant is the first to realise that whilst some embodiments of the present invention may not be able to achieve a 90 degree steer angle when carrying certain loads, the disadvantage of such embodiments can be at least partially overcome by the fact that the lift truck can be designed to be shorter than comparable known lift trucks and hence the rear outer most portion of the lift truck is less likely to strike adjacent racking structure etc. when the lift truck is turning.

However, consideration of FIG. 6A shows that the lift truck is wider at a lower portion and narrower at a higher portion i.e. regions G, in the vicinity of the rear wheels define the maximum width of the lift truck (at a lower portion) and region H, within which the operator sits, defines the width of the truck Z1 at a higher portion. By lifting the load of FIG. 6 above height J as shown in FIG. 6A the load can be turned through 90 degrees on lift truck 110.

With regard to lift truck 10 consideration of FIG. 2 shows that a line F extended from the rear edge of the load intercepts the driver's seat 74 thus the truck cannot be designed to lift wider loads since these would strike the driver when the forks were turned through 90 degrees. In view of this there is no requirement for lift truck 10 to have narrower regions at a higher portion as lift truck 110. However, it should also be noted that whilst lift truck 10 is limited to a specific load width when the load is turned through 90 degrees, there is no limit as to the length of the load that can be carried.

1. A lift truck having a body with ground engaging means and a steer frame rotatable relative to the body via a steer pivot having a steer axis with the steer axis being fixed relative to the body, the lift truck further including a mast mounted on a steer frame and being rotatably fast therewith when considering the steer axis, the lift truck further including front wheels depending from and steerable by the steering frame, in which the mast is rotatably fast with the front wheels when considering the steer axis, and the mast is mounted substantially above the steer pivot.

2. A lift truck as defined in claim 1 in which a portion of the body includes an upwardly orientated projection and a downwardly orientated projection which supports the steer frame.

3. A lift truck as defined in claim 2 in which the upwardly orientated projection is rotationally fast with the downwardly orientated projection.

4. A lift truck as defined in claim 3 in which the upwardly orientated projection is unitary with the downwardly orientated projection.

5. A lift truck as defined in claim 4 in which the upwardly orientated portion and the downwardly orientated portion are in the form of a steer pin.

6. A lift truck as defined in claim 5 in which steer pin is rotatably mounted in said portion by a bearing assembly.

7. A lift truck as defined in claim 6 in which the bearing assembly includes at least one rotating element bearing.

8. A lift truck as defined in claim 7 in which the bearing assembly includes an upper rotating element bearing and a lower rotating element bearing.

9. A lift truck as defined in claim 5 in which the pin is non rotatably mounted in said portion with the steer frame being rotatably mounted on the upper and lower ends of the pin.

10. A lift truck as defined in any of claims 2 to 9 in which the steer frame includes a ‘U’ shaped portion with upper and lower arms of the ‘U’ shaped portion being supported by the upper and lower orientated projections.

11. A lift truck as defined in any preceding claim in which the mast is tiltable about a tilt axis relative to the steer frame with the tilt axis being substantially above the steer pivot.

12. A lift truck as defined in claims 1 to 10 further including a lift carriage being vertically moveable relative to the mast in which the lift carriage is tiltable about a tilt axis relative to the mast with the tilt axis being substantially above the steer pivot.

13. A lift truck as defined in any preceding claim further including a front axle for mounting the front wheels which axle is pivotally connected to the steer frame via an axle pivot.

14. A lift truck as defined in claim 13 in which the axle pivot is substantially below the steer pivot.

15. A lift truck as defined in claim 13 or 14 in which the front wheels are rotatable mounted about an axis on the axle in which the axis is substantially below the steer pivot.

16. A lift truck as defined in any preceding claim in which the body includes a main body portion with a forward projecting arm on which is located the steer axis.

17. A lift truck as defined in claim 16 in which part of the front wheels are capable of being positioned under the arm when steering the truck.

18. A lift truck as defined in claim 16 or 17 in which part of the mast is capable of being positioned over the arm when steering the truck.

19. A lift truck as defined in claim 16 or 17 or 18 in which part of the carriage is capable of being positioned over the arm when steering the truck.

20. A lift truck as defined in claims 16 to 19 in which the arm is substantially parallel sided.

21. A lift truck as defined in claims 16 to 20 in which the arm width is substantially equal to the diameter of the front wheels.

22. A lift truck as defined in claims 16 to 21 in which the mast includes two forks having a substantially vertical rear edge which edge lies substantially against the arm when the forks are turned at 90 degrees to the body of truck left or right as appropriate.

23. A lift truck as defined in any preceding claim in which steer frame can rotate through substantially 90 degrees right and left relative to the body of the truck.

24. A lift truck according to any preceding claim in which the distance D from the steer axis to the load stop is less than half the width Z of the body.

25. A lift truck as defined in claim 24 in which the distance D is greater than the half width Z1 of a higher portion of the body of the lift truck.

26. A lift truck as defined in claims 25 or 26 in which the distance D is less than 400 mm, and in particular less than 300 mm, and in particular less than 200 mm.

27. A lift truck as defined in any preceding claim in which the distance along the arm from the steer pivot to the main body portion of the truck is approximately 800 mm.

28. A lift truck as defined in any preceding claim in which the width of the truck Z is approximately than 1300 mm.
